(19) United States
(12) Patent Application Publication
(10) Pub. No.: US 2014/0078291 A1
(43) Pub. Date: Mar. 20, 2014

(54) Driver Assisting System and Method for a Motor Vehicle

(71) Applicants: Jonas Hammarström, Linkoping (SE); Ognjan Hedberg, Linkoping (SE)

(72) Inventors: Jonas Hammarström, Linkoping (SE); Ognjan Hedberg, Linkoping (SE)

(73) Assignee: Autoliv Development AB, SE-447 Vargarda (SE)

(21) Appl. No.: 14/114,960

(22) PCT Filed: May 7, 2012
(86) PCT No.: PCT/SE2012/050479

§ 371 Date: Oct. 31, 2013

(30) Foreign Application Priority Data
May 10, 2011 (EP) 11003807.2

(51) Int. Cl. G06K 9/00

(52) U.S. Cl. CPC G06K 9/00825
USPC 348/118

(57) ABSTRACT

A driver assisting system (10) for a motor vehicle (20) comprises an imaging means (11) adapted to acquire images from a surrounding of the motor vehicle (20), a processing means (14) adapted to apply image processing to images acquired by the imaging means (11), and a driver assisting means (18) controlled by the processing means (14) to provide information to the driver based on a result of the image processing. The processing means (14) is adapted to detect from the image processing a periodically blinking warning light (22), and to control the driver assisting means (18) in order to inform and/or alert the driver in case a periodically blinking warning light (22) is detected.

### CROSS-REFERENCE TO RELATED APPLICATION

This application claims priority to European Patent Application No. 11003807.2, filed May 10, 2011 and PCT/SE2012/050479, filed May 7, 2012.

### FIELD OF THE INVENTION

The invention relates to a driver assisting system for a motor vehicle, of a type having an imaging means adapted to acquire images from a surrounding of the motor vehicle, a processing means adapted to apply image processing to images acquired by the imaging means, and a driver assisting means controlled by the processing means to provide information to the driver based on a result of the image processing. The invention also relates to a corresponding driver assisting method.

### BACKGROUND

When an emergency vehicle like a police car, an ambulance or a fire engine is approaching or near the a vehicle, the vehicle driver may become aware too late or not at all for different reasons, for example a lack of attention, loud music or noise, hearing impairment, or others. This can result in obstruction of the emergency vehicle and dangerous traffic situations because emergency vehicles usually have to drive fast. But even if the driver becomes aware of the emergency vehicle, he or she may not be able to react in the correct manner because prescribed actions may vary between countries, states or more generally geographical areas due to different kinds of national or local regulations.

The object of the present invention, therefore, is to provide a driver assisting system and method through which the above mentioned problems can be prevented.

### SUMMARY

The invention solves this object by the features of the invention as described herein. The detection of a periodically blinking warning light generated by an emergency vehicle can reliably be accomplished by image processing of images taken by the imaging means. The automatic detection is independent from the awareness of the driver, who is automatically informed or alarmed in case a periodically blinking warning light is detected. Since an optical signal is detected instead of an acoustical signal from the siren of the emergency vehicle, a reliable detection is possible even in the case of strong background noise. In many cases an already existing imaging means, preferably a rear view camera, can be used for the detection of the periodically blinking warning lights, such that additional imaging devices are not necessary.

According to the invention, in case an emergency vehicle is detected, the driver is informed and/or alerted correspondingly through a driver assisting means. In particular, the presence of a detected emergency vehicle may be indicated to the driver via optical, acoustical and/or haptical means. In a preferred embodiment, the presence of a detected emergency vehicle is displayed to the driver on a display device, optionally together with related information like category, speed and/or distance of the emergency vehicle.

Preferably the processing means is adapted to determine the blinking frequency of the warning light, which can be accomplished in particular by tracking a detected light source over several image frames. This allows the processing means to verify that the determined blinking frequency is equal to at least one pre-defined blinking frequency corresponding to the usual warning light blinking frequencies of emergency vehicles like police cars, ambulances or fire engines.

Preferably the processing means is adapted to determine the color of the warning light (blue, orange, red, etc.). This allows the processing means to verify that the determined color is equal to at least one pre-defined color corresponding to the usual warning light colors of emergency vehicles like police cars, ambulances or fire engines. The color information may thus be used to identify or classify the type of emergency vehicle, optionally in combination with geographical information because the emergency light colors may for example change from one country to another. For this application, the imaging means is expediently adapted to extract color information from the acquired images. Therefore, the imaging means preferably includes a color camera or another color sensitive camera.

Preferably the processing means is adapted to verify that the warning light belongs to another vehicle in order to rule out other (in particular static) periodically blinking warning lights for example on gates, specific traffic lights, for example at railway crossings, and the like. For the same reason, the processing means preferably is adapted to verify that the warning light belongs to a moving vehicle. Furthermore, the processing means preferably is adapted to verify that the warning light has a pre-defined position with respect to another vehicle, for example on the roof of an emergency vehicle, or periodically blinking front lights of an emergency vehicle. In order to prove this, the processing means preferably includes a vehicle detection means for detecting other vehicles by image processing of images taken by the imaging means.

Preferably the processing means is adapted to classify a determined warning light as belonging to at least one category of emergency vehicle, for example a police car, an ambulance or a fire engine, because different actions may be recommended for different types of emergency vehicles. The image processing software executed in the processing means preferably a corresponding classifier. The classifier may be based on the recognition of pre-defined patterns of periodically blinking light structures in the acquired images. The classifier may advantageously be a trained classifier.

Preferably the processing means is adapted to determine a speed and/or a distance of the vehicle bearing the warning light. The processing means may then be adapted to control the driver assisting means depending on the determined speed and/or distance of the vehicle bearing the warning light. This is advantageous because an action in the case of a detected warning light is not always necessary. For example if the emergency vehicle is not approaching the vehicle, in particular if the distance to the emergency vehicle increases, and/or if the emergency vehicle is still far away, informing the driver may be unnecessary and can preferably be omitted. Preferably, therefore, the driver is informed only if the processing means determines that the determined distance of the emergency vehicle falls below a pre-determined threshold, and/or if the emergency vehicle approaches the own vehicle.

Preferably the processing means is adapted to control the driver assisting means depending on geographical position information, in particular from a vehicle receiver of a navigation satellite system, a cell phone network and/or another wireless network. It may also be possible to obtain geographical information from image processing of the acquired images, for example on the basis of the design and shape of road signs. The processing means is then able to control the driver assisting means depending on the geographical position information.

### BRIEF DESCRIPTION OF THE DRAWINGS

In the following the invention shall be illustrated on the basis of preferred embodiments with reference to the accompanying drawings, wherein:

FIG. 1 shows a schematic view of a driver assisting system in accordance with this invention; and

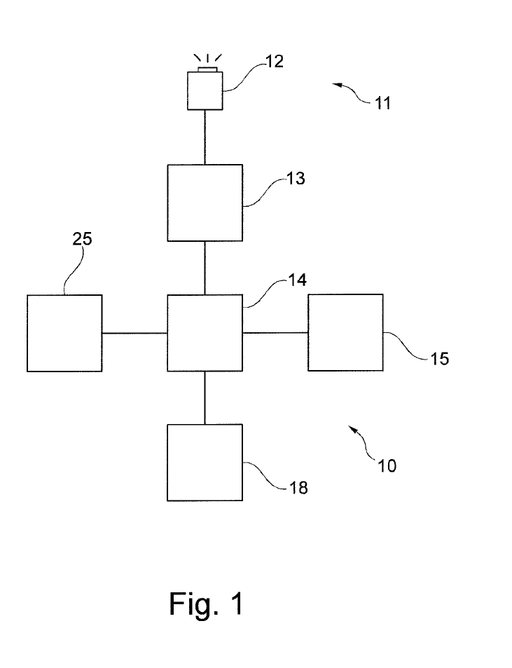

FIG. 2 shows a schematic view of a motor vehicle comprising a driver assisting system in accordance with this invention.

### DETAILED DESCRIPTION

The driver assisting system 10 is mounted in a motor vehicle and includes an imaging means 11 for acquiring images of a region surrounding the motor vehicle. Preferably the imaging means 11 includes one or more optical imaging devices 12, in particular at least one camera. In a preferred embodiment, the imaging means 11 is a rear view camera 12 adapted to acquire images of a region behind the motor vehicle. Alternate embodiments could use one or more sideway looking cameras, front cameras, and/or generally one or more cameras looking in any direction. One camera 12 forming a mono imaging means 11 may generally be sufficient; however, a plurality of imaging devices 12 is not excluded.

The imaging means 11 may be coupled to an image pre-processor 13 adapted to control the capture of images by the imaging means 11, receive the electrical signal containing the image information from the imaging means 11 and perform suited pre-processing to the images. The image pre-processor 13 may be realized by a dedicated hardware circuit. Alternatively the pre-processor 13, or part of its functions, can be realized in the electronic processing means 14.

The image data are then provided to an electronic processing means 14 where image and data processing to be described below is carried out by corresponding software. The processing means 14 is adapted to control at least one driver assistance means 18 depending on the result of the image and data processing. The driver assistance means 18 may in particular includes a display means for displaying information relating to a detected object. However, the invention is not limited to a display means. The driver assistance means 18 may in addition or alternatively include a warning means adapted to provide a collision warning to the driver by suitable optical, acoustical and/or haptical warning signals; one or more restraint systems such as occupant airbags or safety belt tensioners, pedestrian airbags, hood lifters and the like; and/or dynamic vehicle control systems such as brakes or steering means.

The processing means 14 expediently has access to a memory means 25 and preferably to a receiver 15 of a satellite navigation system, a cell phone network or another wireless network. The processing means 14 preferably includes further image recognition functions, for example lane detection, object detection, in particular recognition of other vehicles, or any kind of image processing of images acquired by the rear view camera 12.

The electronic processing means 14 is preferably programmed or programmable and expediently includes a microprocessor or micro-controller. The electronic processing means 14 can preferably be realized in a digital signal processor (DSP). The image pre-processor 13, the electronic processing means 14 and the memory means 25 are preferably realised in an on-board electronic control unit (ECU) and may be connected to the imaging means 11 via a separate cable or a vehicle data bus. In another embodiment the ECU and the imaging device 12 can be integrated into a single unit. All steps from imaging, image pre-processing, image processing to activation or control of driver assistance means 18 are performed automatically and continuously during driving in real time.

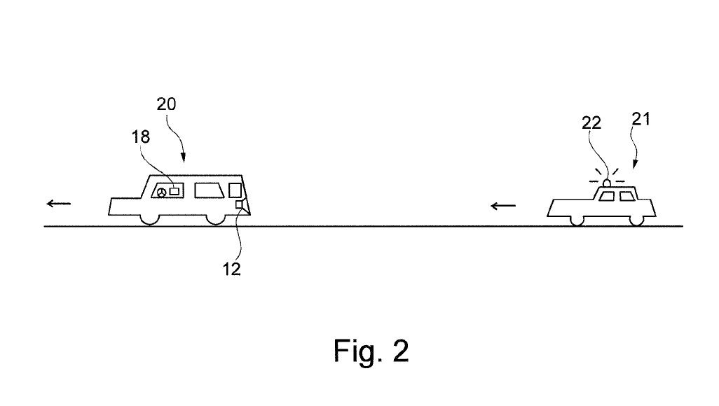

In the following a driver assisting method will be explained with respect to the example shown in FIG. 2. A vehicle 20 moving for example to the left has a rear view camera 12 and a display 18 visible to the driver, which may be installed for example in the middle console of the vehicle 20. If an emergency vehicle 21 with one or more periodically blinking warning lights 22 mounted on the roof of the emergency vehicle 21 is approaching from behind, the image processing means detects the blinking warning lights 22 in the images taken by the rear view camera 12 by suited image processing, in particular by detecting periodical changes in the light intensity in well defined regions of the acquired images.

After having detected periodically blinking warning lights 22, the processing means 14 performs suited processing for verifying that the blinking warning lights 22 belongs to an emergency vehicle 21. In particular, the processing means 14 tracks the warning lights 22 over subsequent image frames and determines the blinking frequency or blinking frequencies of the warning lights 22. Preferably, the processing means 14 determines the color of the warning lights 22. The processing means 14 then proves whether the determined blinking frequency and/or warning light color correspond(s) to usual warning light blinking frequencies or colors of emergency vehicles. Such pre-defined information may for example be stored in the memory 25.

Preferably the processing means 14 is adapted to verify that the warning light 22 is belonging to a moving vehicle, and/or to classify the vehicle 21 as belonging to a pre-determined category like police car, ambulance, fire truck or the like. As another measure for verifying an emergency vehicle, the processing means 14 may be able to recognize a pre-determined light structure or distribution of the warning lights 22 in the images, and/or to verify that the warning lights 22 have a pre-determined relationship to the emergency vehicle 21, for example being positioned on the roof of the emergency vehicle 21 or corresponding to blinking front lights of the emergency vehicle 21.

The processing means 14 may decide that action is required only if the distance to the warning lights is smaller than a pre-defined threshold and/or if the emergency vehicle 21 is approaching the vehicle 20, i.e. if the distance to the warning lights 22 is reducing.

If the processing means 14 has verified that the blinking warning lights 22 belong to an emergency vehicle 22 and action is required, the processing means 14 displays a warning information for the driver on the display 18 indicating the existence of an emergency vehicle 21 in the surrounding of the vehicle 20, preferably together with a recommendation how the driver should react. For example, the processing means 14 may display the type of emergency vehicle 21 detected (“POLICE”) and a recommendation like “SLOW DOWN”, “STOP”, “PULL TO THE RIGHT” or the like. In addition for example also the speed, the distance of the emergency vehicle 21 and/or other useful information may be displayed on the display 18.

The recommendation displayed to the driver by the processing means 14 may be made dependant on the geographical region in which the vehicle 20 is currently travelling, as available through the navigation, cell phone or other wireless receiver 15. For example, in different states or countries, legislation may require different reactions to an approaching emergency vehicle. Therefore, it is advantageous if the processing means 14 is capable of adapting the displayed recommendation to the geographical position of the vehicle 20.

In case a front camera or a camera looking sideways is used in addition or alternatively to the rear view camera 12, the information displayed on the display may advantageously be adjusted according to the camera viewing

While the above description constitutes the preferred embodiment of the present invention, it will be appreciated that the invention is susceptible to modification, variation and change without departing from the proper scope and fair meaning of the accompanying claims.

1. A driver assisting system (10) for a motor vehicle (20), comprising an imaging means (11) adapted to acquire images from a surrounding of the motor vehicle (20), a processing means (14) adapted to apply image processing to the images acquired by the imaging means (11), and a driver assisting means (18) controlled by the processing means (14) for providing information to the driver based on a result of the image processing, the processing means (14) further is adapted to detect from the image processing a periodically blinking warning light (22), and to control the driver assisting means (18) in order to inform or alert the driver in case the periodically blinking warning light (22) is detected.

2. The driver assisting system as claimed in claim 1, further comprising wherein the processing means (14) is further adapted to determine the blinking frequency of the warning light (22).

3. The driver assisting system as claimed in claim 2, further comprising wherein the processing means (14) is adapted to verify that the determined blinking frequency corresponds to at least one pre-defined blinking frequency.

4. The driver assisting system as claimed in claim 1 further comprising wherein the processing means (14) is further adapted to determine the color of the warning light (22).

5. The driver assisting system as claimed in claim 4, wherein the processing means (14) is further adapted to verify that the determined color corresponds to at least one pre-defined color.

6. The driver assisting system as claimed in claim 1 further comprising wherein the processing means (14) is further adapted to verify that the warning light (22) belongs to a stationary vehicle (21) or a moving vehicle (21).

7. The driver assisting system as claimed in claim 1 further comprising wherein the processing means (14) is further adapted to verify that the warning light (22) has a pre-defined pattern.

8. The driver assisting system as claimed in claim 1 further comprising wherein the processing means (14) is further adapted to verify that the warning light (22) has a pre-defined positional relationship to a second motor vehicle (21).

9. The driver assisting system as claimed in claim 1 further comprising wherein the processing means is further adapted to classify the warning light (22) as belonging to at least one category of an emergency second vehicle (21).

10. The driver assisting system as claimed in claim 1 further comprising wherein the processing means (14) is further adapted to determine a speed or a distance of a second vehicle (21) generating the warning light (22).

11. The driver assisting system as claimed in claim 10, wherein the processing means (14) is further adapted to control the driver assisting means (18) depending on at least one of the determined speed and distance of the second vehicle (21) generating the warning light (22).

12. The driver assisting system as claimed in claim 1 further comprising wherein the processing means (14) is further adapted to control the driver assisting means (18) depending on geographical position information.

13. The driver assisting system as claimed in claim 1 further comprising wherein the processing means (14) is further adapted to obtain the geographical position information from a vehicle receiver (15) of at least one of a navigation satellite system, a cellphone network, and a wireless network, and from image processing of the acquired images.

14. The driver assisting system as claimed in claim 1 wherein the imaging means (11) comprises a rear view camera (12).

15. A driver assisting method for a motor vehicle, comprising acquiring images from a surrounding of the motor vehicle, applying image processing to the acquired images, and providing driver assistance information to the driver of the vehicle based on a result of the image processing, detecting, from the image processing, a periodically blinking warning light, and informing or alerting the driver in case a periodically blinking warning light is detected.

16. The driver assisting method as claimed in claim 15, further comprising wherein the processing means (14) further determining the blinking frequency of the warning light (22) and determining if the blinking frequency corresponds to at least one pre-defined blinking frequency.

17. The driver assisting method as claimed in claim 15 further comprising wherein the processing means (14) further determining the color of the warning light (22) and determining that the determined color corresponds to at least one predefined color.

18. The driver assisting method as claimed in claim 15 further comprising the processing means (14) further verifying that the warning light (22) belongs to a stationary second vehicle (21) or a moving second vehicle (21).

19. The driver assisting method as claimed in claim 15 further comprising wherein the processing means (14) further verifying that the warning light (22) has a pre-defined pattern.

20. The driver assisting method as claimed in claim 5 further comprising wherein the processing means (14) is further verifying that the warning light (22) has a pre-defined positional relationship to a second motor vehicle (21).

21. The driver assisting method as claimed in claim 15 further comprising wherein the processing means further classifying the warning light (22) as belonging to at least one category of an emergency second vehicle (21).

22. The driver assisting method as claimed in claim 15 further comprising wherein the processing means (14) further determining a speed or a distance of a second vehicle (21) generating the warning light (22).

23. The driver assisting method as claimed in claim 15 further comprising wherein the processing means (14) further controlling the driver assisting means (18) depending on geographical position information.
